(19) United States
(12) Patent Application Publication
(10) Pub. No.: US 2025/0015533 A1
(43) Pub. Date: Jan. 9, 2025

(54) SHIELD CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Hiroya TANAKA, Mie (JP); Junichi MUKUNO, Mie (JP); Jaeyeon KIM, Mie (JP)

(21) Appl. No.: 18/710,920

(22) PCT Filed: Nov. 16, 2022
(86) PCT No.: PCT/JP2022/042501

§ 371 Date: May 16, 2024

(30) Foreign Application Priority Data
Nov. 24, 2021 (JP) 2021-190367

(51) Int. Cl. H01R 13/533; H01R 13/187

(52) U.S. Cl. CPC H01R 13/533; H01R 13/187; H01R 2201/26

(57) ABSTRACT

A shield connector of a novel structure can stably exhibit desired heat dissipation performance in a shorter heat dissipation path by suppressing a reduction in heat dissipation performance due to an environmental temperature change. A shield connector 10 includes a terminal fitting 16 including a terminal connecting portion 14 to be connected to a mating terminal 12, an insulating housing 18 for accommodating the terminal fitting 16, a shield shell 20 for covering an outer surface of the housing 18, a heat dissipating portion 22 to be held in contact with the shield shell 20 on the outer surface side and held in contact with the terminal connecting portion 14 on an inner surface side in the housing 18, and a spring member 24 for pressing the terminal connecting portion 14 against the heat dissipating portion 22 and the shield shell 20.

### TECHNICAL FIELD

The present disclosure relates to a shield connector.

### BACKGROUND

Patent Document 1 discloses a shield connector provided with a terminal fitting including a hollow cylindrical terminal connecting portion to be connected to a mating terminal, an insulating housing for accommodating the terminal fitting and a shield shell made of metal for covering the outer surface of the housing, and formed with a tip insulating portion for protecting a tip part of the terminal connecting portion by filling an insulating resin into the hollow cylindrical terminal connecting portion and a heat dissipating portion projecting outward from a base end part of the connection terminal portion and expanding in a direction perpendicular to an axis. In this shield connector, the heat dissipating portion projecting outward is integrally formed on the side of the base end part of the connection terminal portion, using the insulating resin filled into the hollow cylindrical terminal connecting portion by insert molding. Thus, heat generated in the terminal connecting portion is quickly dissipated from the heat dissipating portion without via an air layer outside the terminal connecting portion, wherefore the heat dissipation of the shield connector can be improved.

### PRIOR ART DOCUMENT

### Patent Document

Patent Document 1: JP 2019-029179 A

### SUMMARY OF THE INVENTION

### Problems to be Solved

In the shield connector described in Patent Document 1, an air layer (gap) may be formed between contact surfaces of the insulating resin and the terminal connecting portion due to an environmental temperature change during use and heat dissipation performance may be reduced since linear expansion coefficients of the insulating resin and the terminal fitting made of metal are different. Further, since the heat dissipating portion is formed to project outward from the base end part of the terminal connecting portion and expand in the direction perpendicular to the axis, there has been an inherent problem that a distance from the terminal connecting portion where heat is generated most to the heat dissipating portion is long and thermal resistance is large.

Accordingly, a shield connector of a novel structure is disclosed which can stably exhibit desired heat dissipation performance in a shorter heat dissipation path by suppressing a reduction in heat dissipation performance due to an environmental temperature change.

### Means to Solve the Problem

The present disclosure is directed to a shield connector with a terminal fitting including a terminal connecting portion to be connected to a mating terminal, an insulating housing for accommodating the terminal fitting, a shield shell for covering an outer surface of the housing, a heat dissipating portion to be held in contact with the shield shell on the outer surface side and held in contact with the terminal connecting portion on an inner surface side in the housing, and a spring member for pressing the terminal connecting portion against the heat dissipating portion and the shield shell.

### Effect of the Invention

According to the shield connector of the present disclosure, desired heat dissipation performance can be exhibited in a shorter heat dissipation path by suppressing a reduction in heat dissipation performance due to an environmental temperature change.

### BRIEF DESCRIPTION OF THE DRAWINGS

FIG. 1 is a perspective view of a shield connector according to one embodiment.

FIG. 2 is a front view of the shield connector shown in FIG. 1.

FIG. 3 is a section along III-III in FIG. 2.

FIG. 4 is a section along IV-IV in FIG. 3.

FIG. 5 is an exploded perspective view of the shield connector shown in FIG. 1 when viewed from a front surface side.

FIG. 6 is an exploded perspective view of the shield connector shown in FIG. 1 when viewed from a back surface side.

FIG. 7 is an exploded perspective view enlargedly showing an essential part of the shield connector shown in FIG. 1 when viewed from a bottom surface side.

### DETAILED DESCRIPTION TO EXECUTE THE INVENTION

### Description of Embodiments of Present Disclosure

First, embodiments of the present disclosure are listed and described.

(1) The shield connector of the present disclosure is provided with a terminal fitting including a terminal connecting portion to be connected to a mating terminal, an insulating housing for accommodating the terminal fitting, a shield shell for covering an outer surface of the housing, a heat dissipating portion to be held in contact with the shield shell on the outer surface side and held in contact with the terminal connecting portion on an inner surface side in the housing, and a spring member for pressing the terminal connecting portion against the heat dissipating portion and the shield shell.

According to the shield connector of the present disclosure, a part of the housing to be held in contact with the shield shell on the outer surface side and held in contact with the terminal connecting portion on the inner surface side is adopted as the heat dissipating portion instead of a heat dissipating portion formed using an insulating resin filled inside a terminal connecting portion by molding in a conventional structure. Further, the terminal connecting portion is pressed against the heat dissipating portion and the shield shell using the spring member separate from the terminal fitting and the heat dissipating portion. In this way, the heat dissipating portion interposed between the terminal connecting portion and the shield shell can be stably held in contact with the terminal connecting portion and the shield shell utilizing a resilient restoring force of the spring member even if an environmental temperature changes during use. In addition, since the heat dissipating portion is held in contact with the terminal connecting portion of the terminal fitting, the terminal connecting portion having a largest heat generation amount on an electrically conductive path can be directly brought into contact with the shield shell via the heat dissipating portion. As a result, a heat dissipation path can be shortened and desired heat dissipation performance can be stably exhibited as compared to the conventional structure.

Note that an arbitrary shape can be adopted for the spring member if the spring member can hold the terminal connecting portion in contact with the shield shell via the heat dissipating portion by pressing the terminal connecting portion against the heat dissipating portion and the shield shell. Similarly, the heat dissipating portion of the housing is not particularly limited if the heat dissipating portion is a part having an inner surface to be held in contact with the terminal connecting portion and pressed by the spring member and having an outer surface to be pressed against the shield shell by the spring member.

(2) Preferably, the housing includes a housing body for accommodating the terminal fitting and a spring holding member to be assembled with the housing body while holding the spring member. The housing is divided into the housing body and the spring holding member, and the housing body accommodating the terminal fitting and the spring holding member holding the spring member can be assembled with each other. In this way, the spring member is held by the spring holding member in advance in assembling the separate spring member with the housing, wherefore the handleability of the spring member can be improved, a possibility of loss of the spring member can be reduced and the assembly workability of the shield connector can be improved.

(3) Preferably, the housing body includes the heat dissipating portion to be held in contact with the terminal connecting portion and an opening provided in a part facing the heat dissipating portion across the terminal connecting portion in a first direction, the spring holding member includes a holding plate portion for covering the opening of the housing body, the holding plate portion facing the heat dissipating portion in the first direction, the holding plate portion is provided with a holding portion for holding a part of the spring member on a facing surface facing the heat dissipating portion, and the terminal connecting portion is pressed against the heat dissipating portion and the shield shell by a resilient restoring force of the spring member held by the holding portion of the holding plate portion arranged in the opening with the housing body and the spring holding member assembled.

The housing body includes the opening in the part facing across the terminal connecting portion in the first direction, and the spring holding member to be assembled with the housing body includes the holding plate portion covering the opening and facing the heat dissipating portion. The spring member held by the holding portion provided in the holding plate portion can apply a biasing force and press the terminal connecting portion against the heat dissipating portion and the shield shell with the housing body and the spring holding member assembled. In this way, the spring member for pressing the terminal connecting portion against the heat dissipating portion can be accommodated and held in the housing by a simple and reliable structure, and the heat dissipation performance of the shield connector can be advantageously stabilized and maintained.

(4) Preferably, the shield shell includes a first accommodating portion for accommodating the housing body and a second accommodating portion for accommodating the spring holding member, and the shield shell includes a first insertion hole for allowing insertion of the housing body into the first accommodating portion and a second insertion hole for allowing insertion of the spring holding member into the second accommodating portion. The shield shell includes the first and second insertion holes, and the housing body and the spring holding member can be separately assembled with the shield shell through those insertion holes. Thus, the assembly workability of the housing with the shield shell can be improved.

(5) Preferably, the spring holding member includes a mating terminal insertion hole, the mating terminal being inserted through the mating terminal insertion hole, the spring holding member includes a fitting portion and the second accommodating portion of the shield shell includes a fit portion to be fit to the fitting portion, and a displacement of the spring holding member with respect to the shield shell in a pull-out direction of the mating terminal from the mating terminal insertion hole is limited by fitting the fitting portion to the fit portion. If the shield shell includes the second insertion hole for allowing the insertion of the spring holding member into the second accommodating portion and the spring holding member further includes the mating terminal insertion hole, there is a concern that the mating terminal is pulled out in the pull-out direction from the mating terminal insertion hole of the spring holding member. However, the pull-out can be hindered without causing enlargement by a simple structure of providing the fitting portion and the fit portion for hindering the pull-out between the spring holding member and the shield shell.

(6) Preferably, the terminal connecting portion has a rectangular tube shape with an inner hole and the mating terminal is inserted into the inner hole of the terminal connecting portion, and the spring member comes into contact with one side surface facing the heat dissipating portion in the first direction in the terminal connecting portion and another side surface is in contact with the heat dissipating portion. Since the heat dissipation path from the terminal connecting portion toward the shield shell can be provided without via the mating terminal, the heat dissipation performance of the shield connector can be further improved by constructing a shorter heat dissipation path having less thermal resistance. Further, a pressing force of the spring member can be designed without being affected by a contact pressure between the mating terminal and the terminal connecting portion and the heat dissipation performance of the shield connector can be further stabilized.

(7) Preferably, a contact part of the shield shell with the heat dissipating portion is formed to be thicker than other parts. Since the contact part with the heat dissipating portion of the housing is thicker than the other parts in the shield shell, a heat capacity in the contact part is increased and heat can be more quickly dissipated from the heat dissipating portion of the housing to the shield shell.

### Details of Embodiment of Present Disclosure

A specific example of a shield connector of the present disclosure is described below with reference to the drawings. Note that the present disclosure is not limited to these illustrations, but is represented by claims and intended to include all changes in the scope of claims and in the meaning and scope of equivalents.

### Embodiment

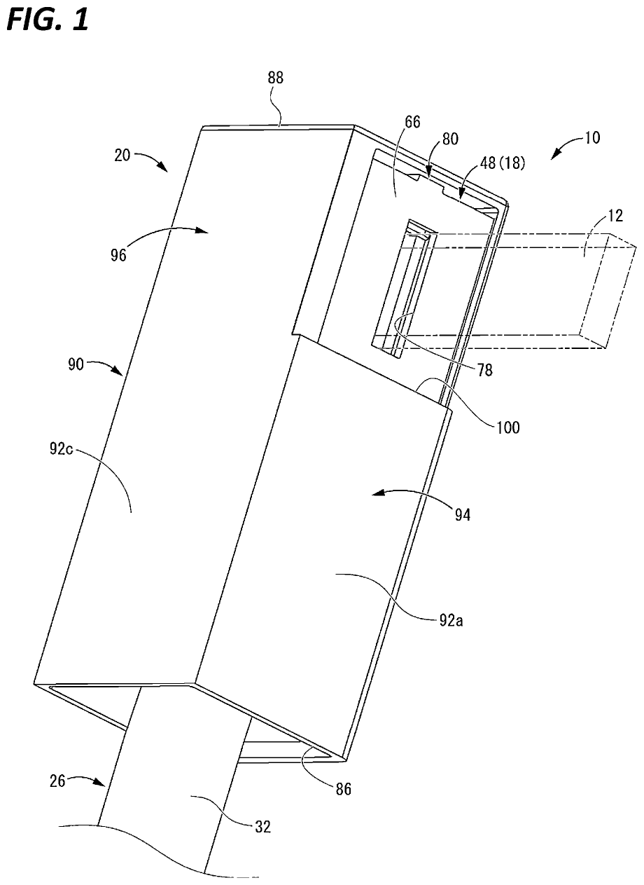

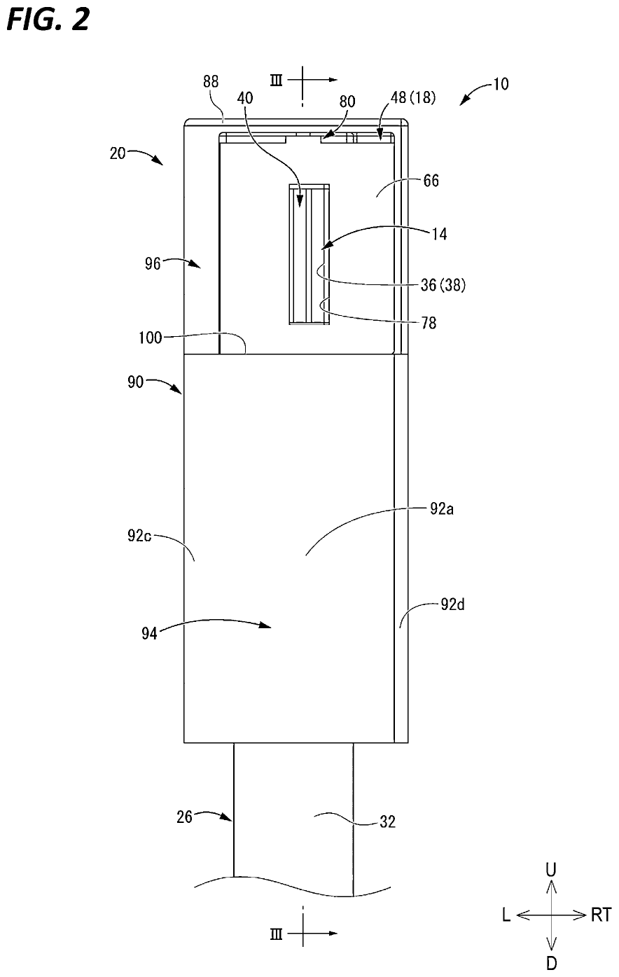

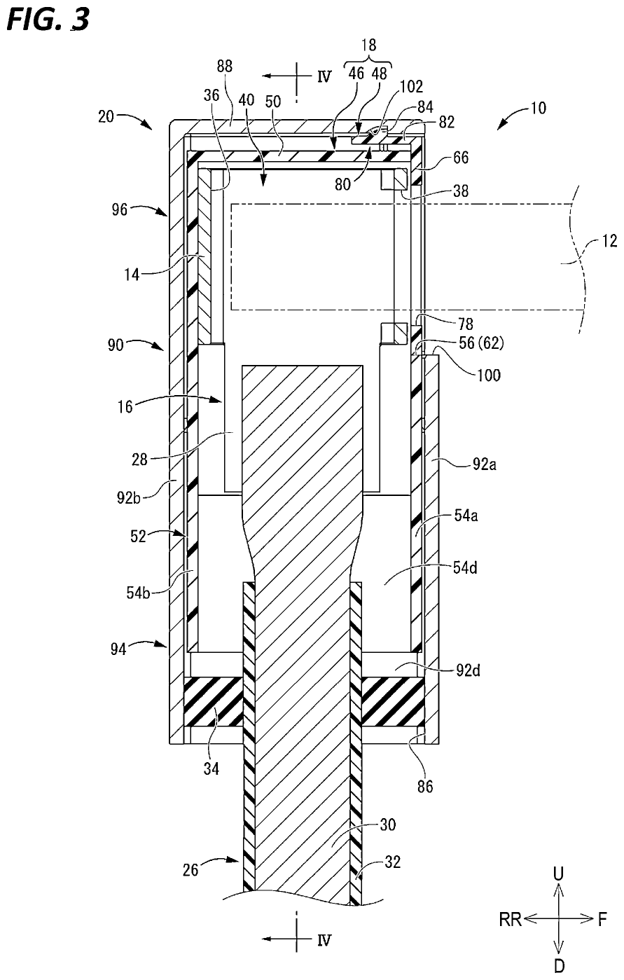

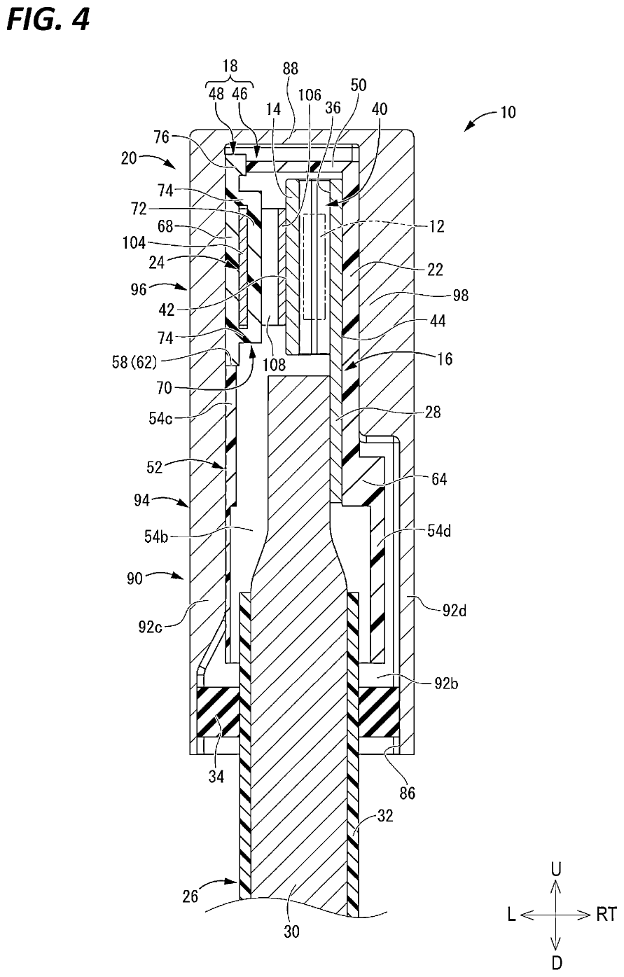

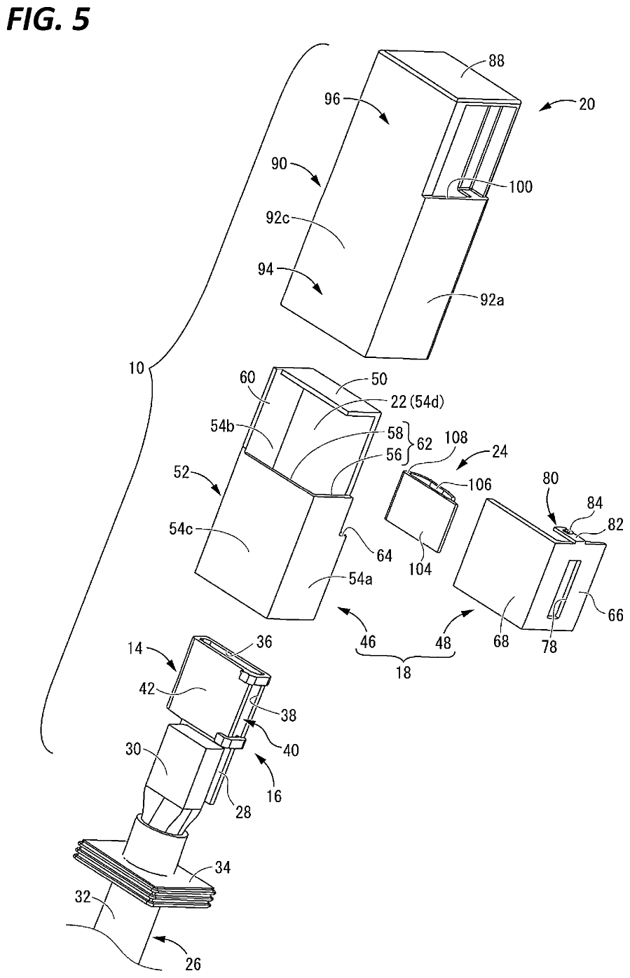

Hereinafter, a shield connector 10 of one embodiment of the present disclosure is described with reference to FIGS. 1 to 7. This shield connector 10 is applied, for example, to an electric vehicle or a hybrid vehicle and used in a large current region of a high-voltage connector from a power control unit (PCU) to a battery. Note that the shield connector 10 can be arranged in an arbitrary orientation, but upper and lower sides are upper and lower sides in FIG. 3, front and rear sides are right and left sides in FIG. 3 and left and right sides are left and right sides in FIG. 4 in the following description. Further, for a plurality of identical members, only some members may be denoted by a reference sign and the others may not be denoted by the reference sign.

### (Shield Connector 10)

The shield connector 10 is provided with a terminal fitting 16 including a terminal connecting portion 14 to be connected to a mating terminal 12. The terminal fitting 16 is accommodated into an insulating housing 18, and the outer surface of the housing 10 is covered by a shield shell 20. Further, the shield connector 10 is provided with a heat dissipating portion 22 to be held in contact with the shield shell 20 on an outer surface side and held in contact with the terminal connecting portion 14 on an inner surface side in the housing 18. Furthermore, the shield connector 10 is provided with a spring member 24 for pressing the terminal connecting portion 14 against the heat dissipating portion 22 and the shield shell 20.

### (Mating Terminal 12)

The shape of the mating terminal 12 is not limited, but is a substantially flat tab shape in this embodiment. Note that, in this embodiment, a mating terminal arrangement portion 40 is provided inside the shield connector 10 as described later, and the mating terminal 12 is inserted into a mating terminal insertion hole 78 provided in the housing 18. The mating terminal 12 arranged in the mating terminal arrangement portion 40 and the terminal connecting portion 14 of the terminal fitting 16 accommodated in the housing 18 are brought into contact to become conductive. That is, in this embodiment, the mating terminal 12 is a male terminal and the terminal connecting portion 14 (terminal fitting 16) is a female terminal.

### (Terminal Fitting 16)

As also shown in FIGS. 4 to 6, the terminal fitting 16 is formed, for example, by bending one flat metal plate into a predetermined shape and formed to extend in a vertical direction as a whole. An upper part of this terminal fitting 16 is the terminal connecting portion 14, and a lower part thereof is a wire connecting portion 28 to be fixed to a wire 26. The wire 26 is a coated wire, and an insulation coating 32 made of synthetic resin is externally fit to a core wire 30. The insulation coating 32 is stripped to expose the core wire 30 in a tip part (upper end part) of the wire 26, and the wire 26 and the terminal fitting 16 are made conductive by fixing the exposed core wire 30 to the wire connecting portion 28 of the terminal fitting 16 by crimping, welding or the like. Note that an annular waterproof rubber 34 having a substantially rectangular outer shape is externally fit and mounted on a part of the wire 26 below the exposed core wire 30.

### (Terminal Connecting Portion 14)

The terminal connecting portion 14 has a substantially flat rectangular tube shape having an inner hole 36 and having a dimension in a front-rear direction larger than a dimension in a lateral direction. This terminal connecting portion 14 having the substantially rectangular tube shape is formed, for example, by bending a flat metal plate and crimping and fixing both end parts in the vertical direction on a front end. In this way, the inner hole 36 is open on both sides in the vertical direction, and communicates with an external space through a front opening 38 provided in an intermediate part in the vertical direction at the front end of the terminal connecting portion 14. The mating terminal 12 is inserted into the inner hole 36 of this terminal connecting portion 14, and an internal space of the terminal connecting portion 14 (inner hole 36) is the mating terminal arrangement portion 40.

Note that, although not shown, contact point portions projecting inward in the lateral direction are, for example, provided in both parts in the lateral direction on the inner surface of the inner hole 36 constituting the mating terminal arrangement portion 40. At the time of inserting the mating terminal 12 into the terminal connecting portion 14, these contact point portions contact the mating terminal 12, whereby the mating terminal 12 and the terminal connecting portion 14 are made electrically conductive. The shape of the contact point portion is not limited, the contact point portion may come into point contact or line contact, and one or more contact point portions may be provided on each of left and right inner surfaces of the inner hole 36.

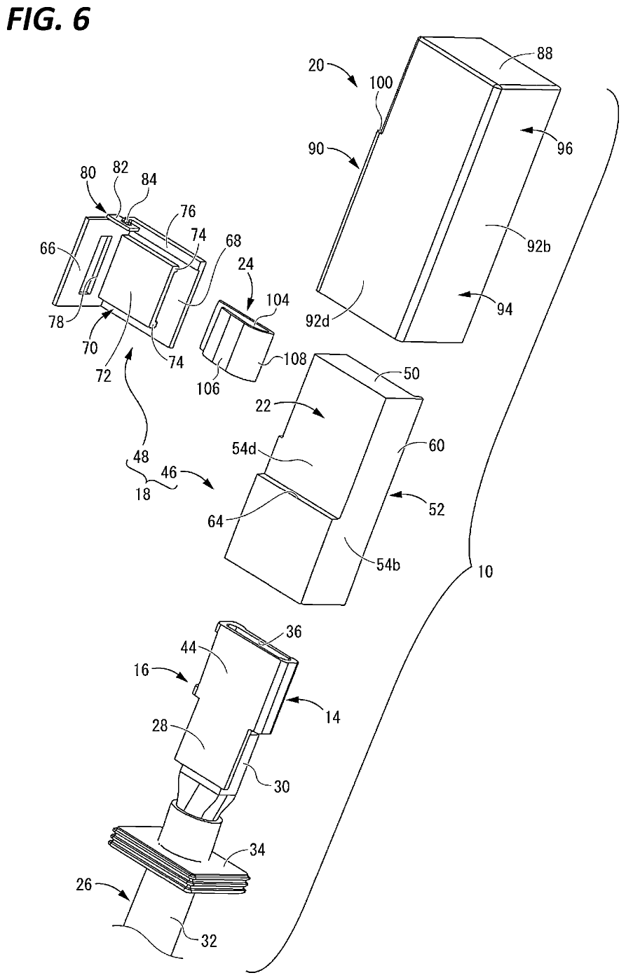

In this embodiment, a part of the terminal connecting portion 14 constituting a right wall portion extends downward to constitute the wire connecting portion 28, and the core wire 30 of the wire 26 is fixed to this wire connecting portion 28 from left. In this way, as also shown in FIGS. 4 and 6, the right end surfaces of the terminal connecting portion 14 and the wire connecting portion 28 continuously extend on the same plane. As a result, as described later, one (left end surface) of side surfaces facing each other in the lateral direction, which is a first direction, serves as a spring member contact surface 42 to be contacted by the spring member 24, and the right end surface of the terminal fitting 16 including the other side surface (right end surface) of the terminal connecting portion 14 serves as a heat dissipating portion contact surface 44 to be held in contact with the heat dissipating portion 22.

### (Housing 18)

The housing 18 includes a housing body 46 for accommodating the terminal fitting 16 and a spring holding member 48 to be assembled with the housing body 46 while holding the spring member 24. Each of these housing body 46 and spring holding member 48 is, for example, made of insulating synthetic resin.

### (Housing Body 46)

The housing body 46 has a substantially bottomed tube shape open downward as a whole, and is provided with a substantially rectangular upper wall portion 50 corresponding to a bottom wall in an upper end part. A substantially tubular peripheral wall portion 52 is provided which projects downward from a peripheral edge part on four sides of the upper wall portion 50. Therefore, the peripheral wall portion 52 is provided with a front wall portion 54a on a front side, a rear wall portion 54b on a rear side and left and right wall portions 54c, 54d on both left and sides.

Here, the front wall portion 54a of the housing body 46 is provided with a front side opening 56 in the form of a cut, and an internal space and an external space of the housing body 46 communicate with each other through this front side opening 56. The front side opening 56 is formed over a predetermined region in the front wall portion 54a and, in this embodiment, formed from an upper end part (part connected to the upper wall portion 50) to a substantially central part in the vertical direction and over an entire length in the lateral direction in the front wall portion 54a.

Further, the left wall portion 54c of the housing body 46 is provided with a left side opening 58 in the form of a cut, and the internal space and the external space of the housing body 46 communicate with each other through this left side opening 58. The left side opening 58 is formed over a predetermined region in the left wall portion 54c and, in this embodiment, has a vertical dimension substantially equal to that of the front side opening 56 and is formed substantially over an entire length in the front-rear direction. Specifically, the left side opening 58 does not reach the rear wall portion 54b, and the rear wall portion 54b of the housing body 46 reaches the left end of the housing body 46 also in a formation region of the left side opening 58. In this way, in a front view of the housing body 46 (state viewed from front), the rear wall portion 54b of the housing body 46 projects more leftward than other parts in the front-rear direction. A movement limiting portion 60 for limiting a rearward movement of the spring holding member 48 when the spring holding member 48 is assembled with the housing body 46 as described later is formed by a left end part (part projecting more leftward than the other parts) of this rear wall portion 54b.

Further, the left side opening 58 reaches a front end part (part connected to the front wall portion 54a), and the front side opening 56 and the left side opening 58 are continuous with each other. In this way, one opening 62 open forward and leftward is constituted by the front side opening 56 and the left side opening 58 in an upper part of the housing body 46 in this embodiment. In other words, the left side opening 58 provided in the left wall portion 52c is open to the front wall portion 54a to constitute one opening 62.

Further, as also shown in FIGS. 4 and 6, a stepped part 64 is provided in an intermediate part in the vertical direction of the right wall portion 54d, and the internal space of the housing body 46 is made larger in a lower part than in an upper part by providing this stepped part 64. In other words, in the right wall portion 54d, a part above the stepped part 64 is located more inward in the lateral direction (leftward) than a part below the stepped part 64. As described later, in the right wall portion 54d, the part above the stepped part 64 serves as the heat dissipating portion 22. Since the terminal connecting portion 14 contacts the heat dissipating portion 22 from inside (left), an opening provided in a part facing the heat dissipating portion 22 across the terminal connecting portion 14 in the lateral direction, which is the first direction, is constituted particularly by the left side opening 58 of the opening 62.

A thick portion 98 provided on the inner surface of a right end wall portion 92d of the shield shell 20 contacts an outer surface side of the heat dissipating portion 22 located more leftward than the lower part by providing the stepped part 64 when the shield shell 20 and the housing body 46 are assembled as described later. Further, in this embodiment, the heat dissipating portion 22 has a predetermined vertical dimension by providing the stepped part 64 in the intermediate part in the vertical direction of the right wall portion 54d, and the right end surface (heat dissipating portion contact surface 44) of the terminal fitting 16 including the wire connecting portion 28 entirely contacts the heat dissipating portion 22 at the time of assembling the shield connector 10 as described later.

### (Spring Holding Member 48)

The spring holding member 48 is shaped to cover the opening 62 in the housing body 46 by being assembled with the housing body 46. That is, the spring holding member 48 is provided with a front side wall portion 66 for covering the front side opening 56 in the opening 62 and a left side wall portion 68 for covering the left side opening 58 in the opening 62 when being assembled with the housing body 46. These front side wall portion 66 and left side wall portion 68 are coupled to each other, and the housing body 46 has a predetermined vertical dimension while being L-shaped as a whole in a plan view (projection in the vertical direction).

In this embodiment, the opening facing the heat dissipating portion in the lateral direction, which is the first direction, is constituted particularly by the left side opening 58 of the opening 62 as described above. In the spring holding member 48, a holding plate portion facing the heat dissipating portion 22 in the first direction (lateral direction) while covering the left side opening 58 is constituted by the left side wall portion 68.

The holding plate portion (left side wall portion 68) is provided with a holding portion 70 for holding a part of the spring member 24 on an inner surface (right surface) facing the heat dissipating portion 22. The shape of the holding portion can be changed depending on the shape of a spring member to be adopted. In this embodiment, the holding portion 70 includes a flat plate portion 72 facing the left side wall portion (holding plate portion) 68 in the lateral direction. This flat plate portion 72 has a predetermined separation distance from the left side wall portion 68, and both ends in the vertical direction thereof are coupled to the left side wall portion 68 substantially over an entire length in the front-rear direction by coupling portions 74, 74. In this way, a space of a predetermined size is formed in a region surrounded by the left side wall portion 68, the flat plate portion 72 and the coupling portions 74, 74. Note that, as also shown in FIGS. 4 and 6, a thick portion 76 thicker than other parts is provided substantially over an entire length in the front-rear direction in an upper end part of the left side wall portion 68.

Further, the mating terminal insertion hole 78, through which the mating terminal 12 is inserted, is formed to penetrate through a substantially central part of the front side wall portion 66 in a plate thickness direction (front-rear direction). The mating terminal insertion hole 78 is formed in a size larger than the mating terminal 12 to be inserted therethrough and has, in this embodiment, a vertically long rectangular shape having a vertical dimension larger than a lateral dimension. Further, the front side wall portion 66 is provided with a fitting portion 80 to be fit to a fit portion 102 of the shield shell 20 when the spring holding member 48 is assembled with the shield shell 20 as described later. In this embodiment, the fitting portion 80 includes a resilient projecting piece 82 projecting rearward from a substantially central part in the lateral direction of the upper end of the front side wall portion 66 and resiliently deformable in the vertical direction, and a locking protrusion 84 projecting upward on the projecting tip of this resilient projecting piece 82. As also shown in FIG. 3, the locking protrusion 84 has a front surface, which is a vertical surface extending in the vertical direction, and a rear surface, which is a curved surface having an upward projecting dimension gradually reduced toward a rear side.

### (Shield Shell 20)

The shield shell 20 is made of metal excellent in heat dissipation. The overall outer shape of the shield shell 20 is substantially similar to that of the housing body 46, and is a substantially bottomed tube shape including a lower opening 86 serving as a first insertion hole. That is, the shield shell 20 is provided with a substantially rectangular upper end wall portion 88 and a tubular wall portion 90 projecting rearward from a peripheral edge part on four sides of the upper end wall portion 88. Therefore, the tubular wall portion 90 includes a front end wall portion 92a on a front side, a rear end wall portion 92b on a rear side and left and right end wall portions 92c, 92d on both left and right sides.

The shield shell 20 is formed in a size capable of accommodating the housing 18 formed by assembling the housing body 46 and the spring holding member 48. That is, the shield shell 20 is provided with a first accommodating portion 94 for accommodating the housing body 46 and a second accommodating portion 96 for accommodating the spring holding member 48. Note that the first and second accommodating portions 94, 96 are not clearly distinguished in the shield shell 20. However, for example, a region below a second insertion hole 100 to be described later in the tubular wall portion 90 of the shield shell 20 serves as the first accommodating portion 94, and a region above the first accommodating portion 94, into which the spring holding member 48 is inserted through the second insertion hole 100, serves as the second accommodating portion 96. Specifically, the first accommodating portion 94 is, for example, constituted by a region surrounded by lower parts of the front end wall portion 92a, the rear end wall portion 92b and the left and right end wall portions 92c, 92d. Further, the second accommodating portion 96 is constituted by a region surrounded by the upper end wall portion 88 and upper parts of the rear end wall portion 92b and the left and right end wall portions 92c, 92d.

In accommodating the housing 18 into the shield shell 20, the inner surface of the shield shell 20 and the outer surface of the housing 18 are held substantially in close contact in the lateral direction. Particularly, as described above, the upper part (heat dissipating portion 22) in the right wall portion 54d of the housing body 46 is located more inward (leftward) in the lateral direction than the lower part and, as shown in FIG. 4, the thick portion 98 formed to be thicker than the other parts is provided on the inner surface of the right end wall portion 92d of the shield shell 20. In this way, the outer surface of the heat dissipating portion 22 and the inner surface of the thick portion 98 are held substantially in close contact. Note that, in the shield shell 20, the left end wall portion 92c is formed to be thicker than the front and rear end wall portions 92a, 92b and the lower part of the right end wall portion 92d, and the thick portion 98 provided in the upper part of the right end wall portion 92 is formed to be even thicker than the left end wall portion 92c.

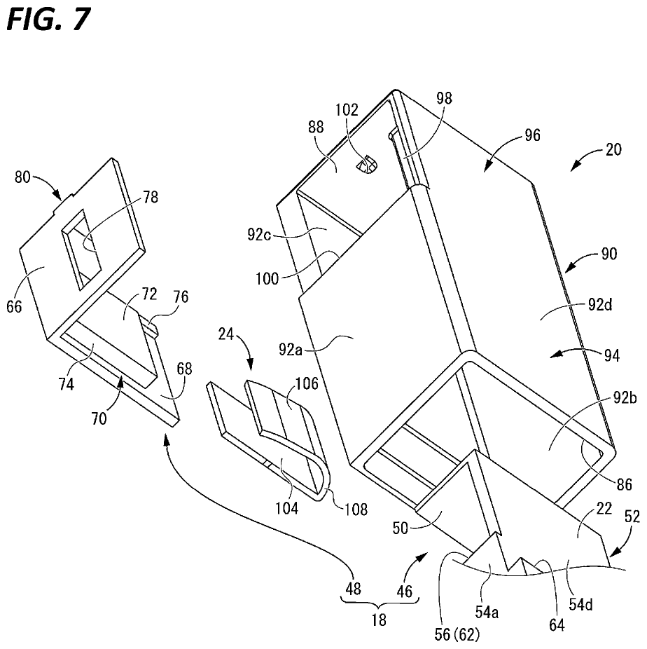

Note that the upper part of the front end wall portion 92a of the shield shell 20 is cut over an entire length in the lateral direction, thereby forming the second insertion hole 100 penetrating through the upper part of the front end wall portion 92a in the front-rear direction. As a result, an internal space and an external space of the shield shell 20 communicate with each other through the second insertion hole 100. This second insertion hole 100 is formed in such a size that the spring holding member 48 is insertable therethrough, and has vertical and lateral dimensions substantially equal to those of the spring holding member 48. Further, as also shown in FIGS. 3 and 7, the fit portion 102 corresponding to the fitting portion 80 of the housing body 46 is formed in the inner surface (lower surface) of the upper end wall portion 88 in the shield shell 20. In this embodiment, the fit portion 102 is formed as a recess shaped to correspond to the locking protrusion 84.

### (Spring Member 24)

The shape of the spring member 24 is not limited if the spring member 24 has a function of pressing the terminal connecting portion 14 against the heat dissipating portion 22 and the shield shell 20. In this embodiment, the spring member 24 is constituted by a leaf spring made of metal. That is, springiness is given to the spring member 24, such as by bending a flat plate made of metal into a substantially U shape, and the spring member 24 includes a base portion 104 to be held by the holding portion 70 of the spring holding member 48 and a resiliently deforming portion 106 folded with respect to the base portion 104 and resiliently deformable in a direction toward or away from the base portion 104. In other words, the base portion 104 and the resiliently deforming portion 106 are coupled via a folded portion 108, and facing each other while being spaced apart by a predetermined distance. When the shield connector 10 is assembled, the resiliently deforming portion 106 is folded forward in a rear end part of the base portion 104, the base portion 104 and the resiliently deforming portion 106 are facing each other in the lateral direction and the resiliently deforming portion 106 is resiliently deformable in the lateral direction with respect to the base portion 104.

### (Assembly Process of Shield Connector 10)

Next, a specific example of an assembly process of the shield connector 10 is described. Note that the assembly process of the shield connector 10 is not limited to the one described below.

First, the terminal fitting 16 is prepared, and the wire 26 is fixed to the wire connecting portion 28 of the terminal fitting 16. Note that the waterproof rubber 34 may be externally fit to the wire 26 before the wire 26 is fixed to the wire connecting portion 28 or may be externally fit to the wire 26 after the wire 26 is fixed to the wire connecting portion 28.

Further, each of the shield shell 20, the housing body 46, the spring member 24 and the spring holding member 48 is separately formed and prepared. Thereafter, the housing body 46 is inserted through the lower opening 86, which is the first insertion hole of the shield shell 20, and the housing body 46 is mounted into the first accommodating portion 94 of the shield shell 20. Since the outer surface of the housing body 46 is held substantially in close contact with the inner surface of the shield shell 20 in the lateral direction, the housing body 46 is inserted into the shield shell 20 substantially without rattling. Note that, when the shield shell 20 and the housing body 46 are assembled, the outer surface of the upper part (heat dissipating portion 22) of the right wall portion 54d in the housing body 46 and the right end wall portion 92d (thick portion 98) of the shield shell 20 may be in contact or may be facing each other in the lateral direction while being slightly separated from each other.

The terminal fitting 16 fixed to the wire 26 is assembled with this assembly of the shield shell 20 and the housing body 46 by being inserted from below. Note that the terminal fitting 16 fixed to the wire 26 is inserted into the assembly of the shield shell 20 and the housing body 46 until the terminal connecting portion 14 is exposed to outside through the front side opening 56 in the housing body 46 and the second insertion hole 100 in the shield shell 20. In this state, the waterproof rubber 34 externally fit to the wire 26 is press-fit into the lower opening (first insertion hole) 86 of the shield shell 20 to seal the lower opening 86 of the shield shell 20 liquid-tight.

In this way, with the shield shell 20, the housing body 46 and the terminal fitting 16 assembled, the terminal connecting portion 14 is exposed to outside through the front side opening 56 in the housing body 46 and the second insertion hole 100 in the shield shell 20 as described above. That is, the space in the inner hole 36 of the terminal connecting portion 14 communicates with the external space through the front opening 38, the front side opening 56 and the second insertion hole 100. Further, in the internal space of the shield shell 20, the spring member contact surface 42, which is the left end surface of the terminal connecting portion 14, is exposed through the left side opening 58 in the opening 62. Furthermore, the heat dissipating portion contact surface 44, which is the right end surface of the terminal fitting 16 including the right end surface of the terminal connecting portion 14, is in contact with the upper part (heat dissipating portion 22) of the right wall portion 54d in the housing body 46 or facing this upper part while being slightly separated.

Subsequently, the spring member 24 is assembled with the spring holding member 48. In other words, the spring member 24 is held by the holding portion 70 in the spring holding member 48. Specifically, the base portion 104 of the spring member 24 is inserted, for example, in a substantially press-fit state into a region surrounded by the left side wall portion (holding plate portion) 68, the flat plate portion 72 and the coupling portions 74, 74 in the spring holding member 48. In this way, the spring member 24 is held by the spring holding member 48 and the detachment of the spring member 24 from the spring holding member 48 is prevented. By assembling the spring member 24 with the spring holding member 48, the resiliently deforming portion 106 in the spring member 24 is located to the right of the flat plate portion 72 in the spring holding member 48.

Then, the spring holding member 48 assembled with the spring member 24 is assembled with the assembly of the shield shell 20, the housing body 46 and the terminal fitting 16. Specifically, the spring holding member 48 assembled with the spring member 24 is inserted from front into the assembly of the shield shell 20, the housing body 46 and the terminal fitting 16 through the second insertion hole 100 in the shield shell 20. In this way, the opening 62 (front side opening 56 and left side opening 58) of the housing body 46 open in the shield shell 20 is covered and closed by the front side wall portion 66 and the left side wall portion 68 in the spring holding member 48.

Note that the insertion of the spring holding member 48 from front into the shield shell 20 through the second insertion hole 100 is limited, for example, by the contact of a rear end part of the left side wall portion 68 of the spring holding member 48 with the movement limiting portion 60 located on the left end part of the housing body 46. When the insertion of the spring holding member 48 into the shield shell 20 is completed, the front side wall portion 66 of the spring holding member 48 is located behind the front end wall portion 92a of the shield shell 20 and the entire spring holding member 48 is accommodated into the second accommodating portion 96 in the shield shell 20.

Further, in assembling the spring holding member 48 with the shield shell 20, the fitting portion 80 of the spring holding member 48 and the fit portion 102 of the shield shell 20 are fit. Specifically, the locking protrusion 84 of the fitting portion 80 comes into contact with the upper end wall portion 88 of the shield shell 20 to resiliently deform the resilient projecting piece 82 downward. When the locking protrusion 84 reaches a position where the recess-like fit portion 102 is formed, the resilient projecting piece 82 is resiliently restored and the locking protrusion 84 is locked to the fit portion 102. In this way, a displacement of the spring holding member 48 with respect to the shield shell 20 in a pull-out direction of the mating terminal 12 from the mating terminal insertion hole 78 (direction from rear to front) is limited. In this way, the shield connector 10 is completed by assembling the spring holding member 48 assembled with the spring member 24 with the assembly of the shield shell 20, the housing body 46 and the terminal fitting 16.

In the thus assembled shield connector 10, the front opening 38 in the terminal connecting portion 14 and the mating terminal insertion hole 78 in the spring holding member 48 are aligned with each other. That is, the front side opening 56 in the housing body 46 is covered by the front side wall portion 66 by assembling the spring holding member 48, but the space in the inner hole 36 of the terminal connecting portion 14 communicates with the external space through the front opening 38, the mating terminal insertion hole 78 and the second insertion hole 100.

Further, the spring member 24 arranged in the opening of the housing body 46 (particularly the left side opening 58 of the opening 62) contacts the terminal connecting portion 14 from left inside the housing 18. At that time, by pressing the resiliently deforming portion 106 by the terminal connecting portion 14, the spring member 24 is resiliently deformed in a direction toward the base portion 104 from a natural state before the spring member 24 contacts the terminal connecting portion 14. A resilient restoring force of this resiliently deforming portion 106 in a direction separating from the base portion 104 is applied as a biasing force to the terminal connecting portion 14 and the right wall portion 54d of the housing body 46 is pressed from the inner surface side by the right end surface (heat dissipating portion contact surface 44) of the terminal connecting portion 14. Further, the thick portion 98 on the right end wall portion 92d of the shield shell 20 is pressed from the inner surface side by the right wall portion 54d of the housing body 46 pressed from the inner surface side in this way.

That is, in the shield connector 10 in the assembled state, the biasing force of the spring member 24 is constantly applied to the terminal connecting portion 14, the terminal connecting portion 14 is pressed against the housing body 46 and the housing body 46 is pressed against the shield shell 20. In short, the terminal connecting portion 14 is pressed against the shield shell 20 via the housing body 46, and pressed against the housing body 46 and the shield shell 20 by the spring member 24.

The mating terminal 12 is inserted into such a shield connector 10 through the mating terminal insertion hole 78 as shown by two-dot chain lines in FIG. 1 and the like. In this way, the mating terminal 12 is arranged in the mating terminal arrangement portion 40 in the inner hole 36 of the terminal connecting portion 14 and the terminal connecting portion 14 and the mating terminal 12 are made electrically conductive by the mating terminal 12 coming into contact with the unillustrated contact point portions provided on the inner surface of the terminal connecting portion 14. Heat generated as these terminal connecting portion 14 and mating terminal 12 become electrically conductive is dissipated to outside via the right wall portion 54d of the housing body 46 and the right end wall portion 92d of the shield shell 20. Therefore, in this embodiment, the heat dissipating portion 22 to be held in contact with the shield shell 20 on the outer surface side and held in contact with the terminal connecting portion 14 on the inner surface side in the housing 18 is constituted by the upper part of the right wall portion 54d in the housing body 46.

In the shield connector 10 of this embodiment, the spring member 24 is assembled inside the housing 18, and a biasing force generated as the spring member 24 is assembled presses the terminal connecting portion 14 against the heat dissipating portion 22 in the housing 18 and presses the heat dissipating portion 22 against the shield shell 20. A gap is easily formed between different materials due to a difference in linear expansion coefficient, for example, if an environmental temperature largely changes. However, in the shield connector 10 of this embodiment, the formation of a gap (air layer) is suppressed even if the environmental temperature largely changes. As a result, a reduction in heat dissipation performance is suppressed and heat can be dissipated with desired heat dissipation performance. Further, relatively high heat generation is caused by the energization of the contact point portions between the terminal connecting portion 14 and the mating terminal 12. However, since heat is dissipated from these contact point portions to outside only via the heat dissipating portion 22 and the shield shell 20, a short heat dissipation path can be set and heat dissipation performance is improved. As just described, since an improvement in heat dissipation performance is achieved in this embodiment, it is, for example, possible to make the terminal fitting 16 itself smaller and, consequently, the entire shield connector 10 can be reduced in size and cost.

Particularly, in this embodiment, the wall portion on the right side of the terminal connecting portion 14 extends downward to constitute the wire connecting portion 28, and the core wire 30 in the wire 26 is fixed thereto. The heat dissipating portion 22 extends not only to the contact point portions between the terminal connecting portion 14 and the mating terminal 12, but also to the fixed part of the wire connecting portion 28 and the core wire 30. Thus, in addition to heat generated between the terminal connecting portion 14 and the mating terminal 12, heat generated in a connected part of the wire connecting portion 28 and the core wire 30 having a relatively large heat generation amount is also dissipated via the heat dissipating portion 22 and the shield shell 20, wherefore heat dissipation performance is further improved.

The housing 18 includes the housing body 46 for accommodating the terminal fitting 16 and the spring holding member 48 to be assembled with the spring member 24, and the spring holding member 48 is assembled with the housing body 46 with the spring member 24 assembled with the spring holding member 48. In this way, even if the spring member 24 is a small member, the spring member 24 can be assembled with the housing body 46 in a state assembled with the larger spring holding member 48. Thus, a possibility of loss of the spring member 24 can be reduced and handleability can be improved, whereby assembly workability is improved.

Particularly, by assembling the spring holding member 48 assembled with the spring member 24 with the housing body 46, the spring member 24 is compressed from an initial state and the terminal connecting portion 14 is pressed against the heat dissipating portion 22 and the shield shell 20 by a resilient restoring force of the spring member 24. In this way, the spring member 24 can be compressed by a simple structure and the resilient restoring force associated with the deformation of the spring member 24 can be more reliably utilized as a biasing force for pressing the terminal connecting portion 14 against the heat dissipating portion 22 and the shield shell 20.

The shield shell 20 includes the first accommodating portion 94 for accommodating the housing body 46 and the second accommodating portion 96 for accommodating the spring holding member 48, the housing body 46 is inserted into the first accommodating portion 94 through the first insertion hole (lower opening 86), and the spring holding member 48 is inserted into the second accommodating portion 96 through the second insertion hole 100. In this embodiment, an insertion direction (direction from down to up) of the housing body 46 into the first accommodating portion 94 and an insertion direction (direction from front to rear) of the spring holding member 48 into the second accommodating portion 96 are different. Particularly, in this embodiment, in inserting the spring holding member 48 into the second accommodating portion 96, the resiliently deforming portion 106 of the spring member 24 is inserted while being pressed against the terminal connecting portion 14. Therefore, in this embodiment, the housing body 46 can be inserted with a small insertion resistance even over a relatively long distance in inserting the housing body 46 into the first accommodating portion 94, and the spring holding member 48 can be inserted over a short distance even with a relatively large insertion resistance in inserting the spring holding member 48 into the second accommodating portion 96. In this way, the housing body 46 and the spring holding member 48 can be easily assembled with the shield shell 20 and the assembly workability of the shield connector 10 is improved.

Particularly, the spring holding member 48 is provided with the fitting portion 80, the shield shell 20 is provided with the fit portion 102, and these fitting portion 80 and fit portion 102 are fit at the time of assembling the spring holding member 48 and the shield shell 20. Thus, the detachment of the spring holding member 48 from the shield shell 20 together with the mating terminal 12 is prevented, for example, in pulling out the mating terminal 12 arranged in the mating terminal arrangement portion 40 in the shield connector 10 through the mating terminal insertion hole 78. Further, by constituting the fitting portion 80 by the resilient projecting piece 82 including the locking protrusion 84 and constituting the fit portion 102 by a recess, into which the locking protrusion 84 is fit, as in this embodiment, it can be also confirmed that the spring holding member 48 has been assembled with the shield shell 20 by a sound or vibration (feeling) given in fitting the locking protrusion 84 into the fit portion 102.

The terminal connecting portion 14 has the rectangular tube shape, the left end surface, which is one side surface, serves as the spring member contact surface 42 and is contacted by the spring member 24, and the right end surface, which is the other side surface, serves as the heat dissipating portion contact surface 44 and is contacted by the heat dissipating portion 22. In this way, the terminal connecting portion 14 biased by the spring member 24 is directly pressed against the heat dissipating portion 22 and the biasing force of the spring member 24 can be efficiently utilized as a pressing force to the heat dissipating portion 22. Further, since the mating terminal 12 is inserted into the inner hole 36 of the terminal connecting portion 14 having the rectangular tube shape, the mating terminal 12 is not arranged on the heat dissipation path and the heat dissipation performance can be improved by shortening the heat dissipation path. Furthermore, a contact pressure between the mating terminal 12 and the terminal connecting portion 14 and the biasing force of the spring member 24 (pressing force to the heat dissipating portion 22) can be independently and separately set, and heat dissipation performance can be improved while the mating terminal 12 and the terminal connecting portion 14 are more reliably made conductive.

The thick portion 98 thicker than the other parts is provided on the right end wall portion 92d of the shield shell 20, and the heat dissipating portion 22 contacts the thick portion 98 on the outer surface side. That is, heat generated in the terminal connecting portion 14 is dissipated via the heat dissipating portion 22 and the thick portion 98, whereby a heat capacity of the shield shell 20 in a heat dissipating part can be increased and heat dissipation performance is improved. Particularly, by providing the shield shell 20 with the thick portion 98 instead of thickening the heat dissipating portion 22 in the housing 18, a distance of the heat dissipating portion 22 made of synthetic resin inferior in thermal conductivity to the shield shell 20 can be set to be short on the heat dissipation path and heat dissipation performance is further improved.

### OTHER EMBODIMENTS

The technique described in this specification is not limited to the above described and illustrated embodiment. For example, the following embodiments are also included in the technical scope of the technique described in this specification.

(1) The spring member is not limited to the one bent into a substantially U shape as in the illustrated embodiment if the spring member can press the terminal connecting portion against the heat dissipating portion and the shield shell. For example, the spring member may be a coil spring, a resilient tongue piece formed by cutting and raising a central part of a flat plate member toward one side in a plate thickness direction, or the like. Further, according to the shape of the spring member to be adopted, the shape of the holding portion in the spring holding member can be appropriately designed and changed.

(2) Although the first insertion hole for allowing the insertion of the housing body 46 into the first accommodating portion 94 of the shield shell 20 is constituted by the lower opening 86 open downward and the second insertion hole 100 for allowing the insertion of the spring holding member 48 into the second accommodating portion 96 is open forward in the above embodiment, there is no limitation to this mode. For example, after the spring holding member holding the spring member is assembled with the housing body, the assembly of these spring holding member and housing body may be inserted through the lower opening of the shield shell. That is, the first insertion hole for allowing the insertion of the housing body into the first accommodating portion and the second insertion hole 100 for allowing the insertion of the spring holding member into the second accommodating portion may be both constituted by the lower opening.

(3) In the above embodiment, the right wall portion of the terminal connecting portion 14 in the terminal fitting 16 extends downward to constitute the wire connecting portion 28 and is fixed to the core wire 30 and the connected part of the wire connecting portion 28 and the core wire 30 is also in contact with the heat dissipating portion 22 in the terminal fitting 16 and the heat dissipating portion 22 is in contact with the shield shell 20, whereby heat in the connected part of the wire connecting portion 28 and the core wire 30 can also be dissipated. However, there is no limitation to this mode. That is, the left wall portion of the terminal connecting portion may extend downward to constitute the wire connecting portion and be fixed to the core wire, and the wire connecting portion may not contact the heat dissipating portion. Therefore, heat in the connected part of the wire connecting portion and the core wire may not be dissipated or may be hardly dissipated via the heat dissipating portion and the shield shell, and may be dissipated through another heat dissipation path.

(4) The fitting structure at the time of assembling the spring holding member and the shield shell is not essential. Even if the fitting structure is provided, the shield shell may be provided with the locking protrusion and the spring holding member may be provided with the recess-like fit portion, for example, contrary to the above embodiment. Further, the spring holding member may be fit to the housing body.

(5) The thick portion on the inner surface of the right end wall portion of the shield shell is not essential. For example, the shield shell may have a substantially constant thickness over the entirety thereof or the heat dissipating portion may be thickened and brought into contact with the right end wall portion of the shield shell.

(6) In the above embodiment, the terminal connecting portion 14 and the heat dissipating portion 22 and/or the heat dissipating portion 22 and the shield shell 20 may be in contact or slightly separated in a state before the spring member 24 is assembled, i.e. in a state before the spring holding member 48 is assembled with the assembly of the shield shell 20, the housing body 46 and the terminal fitting 16. The terminal connecting portion 14 may be pressed against the heat dissipating portion 22 and the shield shell 20 by assembling the spring member 24 (spring holding member 48).

### LIST OF REFERENCE NUMERALS

10 shield connector
12 mating terminal
14 terminal connecting portion
16 terminal fitting
18 housing
20 shield shell
22 heat dissipating portion
24 spring member
26 wire
28 wire connecting portion
30 core wire
32 insulation coating
34 waterproof rubber
36 inner hole
38 front opening
40 mating terminal arrangement portion
42 spring member contact surface
44 heat dissipating portion contact surface
46 housing body
48 spring holding member
50 upper wall portion
52 peripheral wall portion
54a front wall portion
54b rear wall portion
54c left wall portion
54d right wall portion
56 front side opening
58 left side opening
60 movement limiting portion
62 opening
64 stepped part
66 front side wall portion
68 left side wall portion (holding plate portion)
70 holding portion
72 flat plate portion
74 coupling portion
76 thick portion
78 mating terminal insertion hole
80 fitting portion
82 resilient projecting piece
84 locking protrusion
86 lower opening (first insertion hole)
88 upper end wall portion
90 tubular wall portion
92a front end wall portion
92b rear end wall portion
92c left end wall portion
92d right end wall portion
94 first accommodating portion
96 second accommodating portion
98 thick portion
100 second insertion hole
102 fit portion
104 base portion
106 resiliently deforming portion
108 folded portion

1. A shield connector, comprising:
a terminal fitting including a terminal connecting portion to be connected to a mating terminal;
an insulating housing for accommodating the terminal fitting;
a shield shell for covering an outer surface of the housing;
a heat dissipating portion to be held in contact with the shield shell on the outer surface side and held in contact with the terminal connecting portion on an inner surface side in the housing; and
a spring member for pressing the terminal connecting portion against the heat dissipating portion and the shield shell.

2. The shield connector of claim 1, wherein the housing includes a housing body for accommodating the terminal fitting and a spring holding member to be assembled with the housing body while holding the spring member.

3. The shield connector of claim 2, wherein:
the housing body includes the heat dissipating portion to be held in contact with the terminal connecting portion and an opening provided in a part facing the heat dissipating portion across the terminal connecting portion in a first direction,
the spring holding member includes a holding plate portion for covering the opening of the housing body, the holding plate portion facing the heat dissipating portion in the first direction,
the holding plate portion is provided with a holding portion for holding a part of the spring member on a facing surface facing the heat dissipating portion, and
the terminal connecting portion is pressed against the heat dissipating portion and the shield shell by a resilient restoring force of the spring member held by the holding portion of the holding plate portion arranged in the opening with the housing body and the spring holding member assembled.

4. The shield connector of claim 3, wherein:
the shield shell includes a first accommodating portion for accommodating the housing body and a second accommodating portion for accommodating the spring holding member, and
the shield shell includes a first insertion hole for allowing insertion of the housing body into the first accommodating portion and a second insertion hole for allowing insertion of the spring holding member into the second accommodating portion.

5. The shield connector of claim 4, wherein:
the spring holding member includes a mating terminal insertion hole, the mating terminal being inserted through the mating terminal insertion hole,
the spring holding member includes a fitting portion and the second accommodating portion of the shield shell includes a fit portion to be fit to the fitting portion, and
a displacement of the spring holding member with respect to the shield shell in a pull-out direction of the mating terminal from the mating terminal insertion hole is limited by fitting the fitting portion to the fit portion.

6. The shield connector of claim 1, wherein:
the terminal connecting portion has a rectangular tube shape with an inner hole and the mating terminal is inserted into the inner hole of the terminal connecting portion, and
the spring member comes into contact with one side surface facing the heat dissipating portion in the first direction in the terminal connecting portion and another side surface is in contact with the heat dissipating portion.

7. The shield connector of claim 1, wherein a contact part of the shield shell with the heat dissipating portion is formed to be thicker than other parts.
